(19) United States
(12) Patent Application Publication
(10) Pub. No.: US 2024/0281767 A1
(43) Pub. Date: Aug. 22, 2024

(54) RECRUITMENT AUGMENTATION WITH DIGITAL FOOTPRINT UTILIZATION

(71) Applicant: Kyndryl, Inc., New York, NY (US)

(72) Inventors: Sanjana SAHAYARAJ, Chennai (IN); Balakrishna Saravanan KESAVAN, Chennai (IN); Khanij KUMAR S G, Bangalore (IN)

(21) Appl. No.: 18/110,492

(22) Filed: Feb. 16, 2023

(51) Int. Cl. G06Q 10/1053; G06Q 50/00

(52) U.S. Cl. CPC G06Q 10/1053; G06Q 50/01

(57) ABSTRACT

A method including: identify candidate pool resources by analyzing a job description; posting the job description at the candidate pool resources; identifying candidates from the candidate pool resources; determining a candidate score of each of the candidates based on an identified candidate information source; and selecting a set of the candidates based on the candidate score.

### BACKGROUND

Aspects of the present invention relate generally to recruitment of candidates for jobs, and, more particularly, to augmenting recruitment with public digital footprints of potential candidates.

Recruitment of candidates that match a job description may be done through a recruiter reviewing potential candidates. However, some of the potential top candidates may not know about the position or the recruiter may not know about the potential top candidates. In addition, finding the best candidate to fit the job description may not take into consideration the fit of the candidate to a culture of a company. In known recruiting practices, a candidate's resume and/or interviews may provide a limited insight into a candidate's fit with the company culture.

### SUMMARY

In a first aspect of the invention, there is a computer-implemented method including: identifying, by a computing device, candidate pool resources by analyzing a job description; posting, by the computing device, the job description at the candidate pool resources; identifying, by the computing device, candidates from the candidate pool resources; determining, by the computing device, a candidate score of each of the candidates based on candidate data from an identified candidate information source; and selecting, by the computing device, a set of the candidates based on the candidate score.

In another aspect of the invention, there is a computer program product including one or more computer readable storage media having program instructions collectively stored on the one or more computer readable storage media. The program instructions are executable to: analyze a job description utilizing an extracted keyword; identify candidate pool resources based on the analyzed job description; post the job description at the candidate pool resources; analyze the job description utilizing an extracted keyword; identify source equivalents and candidate activities based on the extracted keyword; identify candidates from the candidate pool resources; determine a candidate score of each of the candidates based on an identified candidate information source; and select a candidate set of the candidates based on the candidate score.

In another aspect of the invention, there is system including a processor, a computer readable memory, one or more computer readable storage media, and program instructions collectively stored on the one or more computer readable storage media. The program instructions are executable to: analyze a job description; identify candidate pool resources based on the job description; identify candidates from the candidate pool resources; determine a candidate score of the candidates based on candidate data from an identified candidate information source; identify an augmenting candidate information source for candidate data; collect the candidate data from the identified augmenting candidate information source and the augmenting candidate information source; analyze the candidate data to determine a strength of each of the candidates; and select a candidate set of the candidates based on the candidate score and the determined strength of each of the candidates.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows a flowchart of an exemplary method of identifying candidate activities and candidate information sources in accordance with aspects of the invention.

FIG. 7 shows a flowchart of an exemplary method of analyzing candidate activities in accordance with aspects of the invention.

FIG. 8 shows a flowchart of an exemplary method of determining originality of a candidate activity in accordance with aspects of the invention.

FIG. 9 shows a flowchart of an exemplary method of identifying candidate pool resources in accordance with aspects of the invention.

FIG. 10 shows a flowchart of an exemplary method of analyzing candidate activities and summarizing candidate information in accordance with aspects of the invention.

FIG. 11 shows a flowchart of an exemplary method of generating adapted interview questions in accordance with aspects of the invention.

### DETAILED DESCRIPTION

Aspects of the present invention relate generally to recruitment of candidates for jobs and, more particularly, to augmenting recruitment practices by utilizing public digital footprint information. In embodiments, a computing device may use natural language processing to determine candidate pool resources based on an analysis of a job description. The candidate pool resources includes sources (e.g., websites and/or applications) from which candidates may be chosen and from which information about candidates may be collected. In this manner, implementations of the invention provide a method, computer program product, and system of augmenting candidate recruitment for a job description. The augmented recruitment process offers more dimensions of assessment for candidate analysis and scoring mechanisms. The method, computer program product, and system may utilize multiple digital sources to help decide if a candidate will be a right fit for the job, team, and culture.

In embodiments, the method, computer program product, and system may include broadcasting a job posting to a candidate pool by extracting keywords from a job description; determining alternate candidate identifiers; and identifying candidate activities and sources of candidate activities. In particular, the sources of candidate activities may include candidate accounts on various platforms. In embodiments, the method, computer program product, and system may link alternate candidate identifiers together. For example, candidate identifiers may include usernames and or other identifiers used by a candidate on one or more platforms of the candidate pool resources. In embodiments, the method, computer program product, and system may extract information from sources of candidate data, such as sentiment, frequency, novelty of posts, engagement by other users, and relevance to job descriptions. Thus, the method, computer program product, and system may provide a more holistic assessment with scoring of the candidates for a job. The scoring of the candidate may be based on a fit of the candidate to a job description (i.e., whether the candidate matches the job description). For example, the scoring may be done on a scale from 1-10, depending on the fit of the candidate to the job description.

In embodiments, the method, computer program product, and system may also include customization of interview questions based on the job description and public digital footprint of the candidate. For example, a candidate with public activities that match the job description may be asked for further details regarding those activities. In embodiments, the method, computer program product, and system may be adaptable to any job or rules for a job by providing the ability to opt-in or opt-out of the usage of the method, computer program product, and system of assessing the candidate. The job may be described in the job description (i.e., posting), and the rules of the job may include wanted traits that are not included in the job description. For example, the rules of the job may relate to, for example, the company culture and/or soft skills (e.g., ability to give presentations).

In recruiting systems, merely reviewing a candidate's resume and reviewing candidates that have submitted an application to an open job description is not enough. Further, in known recruiting systems, candidates may hide inadequacies by memorizing or repeatedly practicing known technical and emotional quotient interview questions which may be unrelated to job functions. Thus, in known recruiting systems, simply relying on the candidate's resume and/or interview results for recruitment is not enough. In order to find the best candidates (i.e., matching a candidate with the job description and company culture), directed searches may need to be performed for the candidates, candidate data may need to be augmented with public digital footprints, and directed interview questions may need to be asked in order to enhance the recruitment process.

In recruiting systems, a lack of reach to find the best candidates, viewing a candidate's qualification primarily through a resume, and limitations in job interviews result in an incomplete assessment of a candidate. Accordingly, in known systems, by having the incomplete assessment of the candidates, a candidate may not match or fit with the job description. Thus, a more holistic assessment may be needed for a candidate of a job description. In these embodiments, a holistic assessment may include the use of public digital footprints of a candidate.

These technical issues are now solved in the present invention, in which a holistic assessment resolves technical problems with known methods of recruitment by expanding and/or focusing reach for candidates to candidate pool resources that may not have been considered by a recruiter. The technical solution includes, for example, providing an assessment of a candidate through finding and analyzing the candidate's public digital footprint and providing interview customization for a candidate's assessed strengths and/or weaknesses. The identification of candidate pool resources and candidate data may be determined through natural language processing of information to score a candidate's digital activity and identify better resources for finding candidates matching a job description. Additionally, the augmented recruiting method may increase recruiting and increase retention rates for candidates with a better team synergy and a better company fit through an assessment of multiple dimensions of a candidate. Further, as the number of candidates increase, evaluation of those candidates require greater resources and incur more costs without adequately matching a candidate's work and interests against a job description. Thus, embodiments may provide an improved method, computer program product, and system for matching a candidate to a job description in comparison to known systems.

It should be understood that, to the extent implementations of the invention collect, store, or employ personal information provided by, or obtained from, individuals (for example candidates to a job posting), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

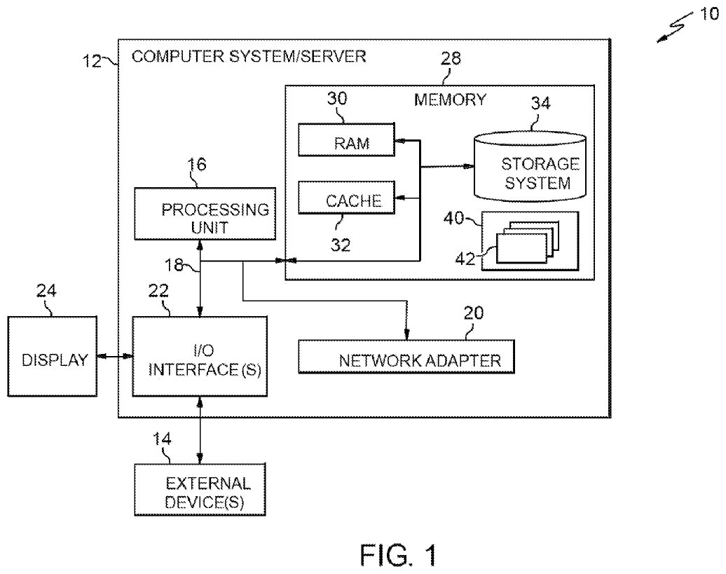

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

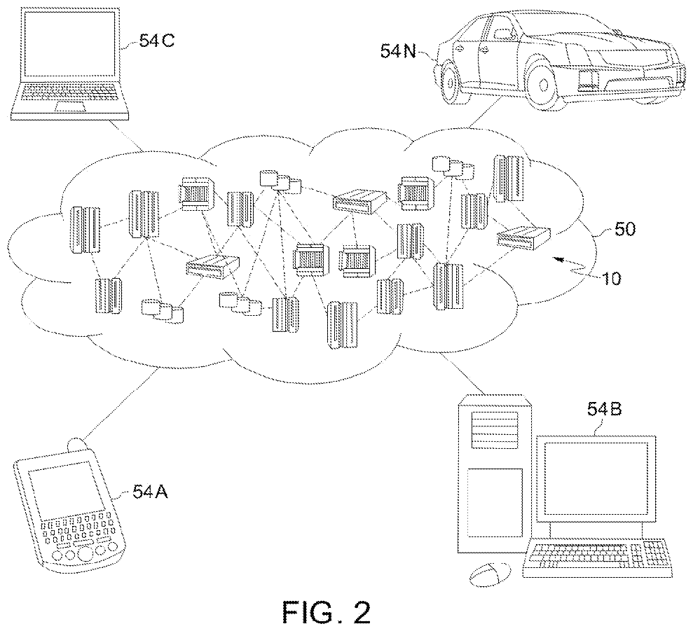

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

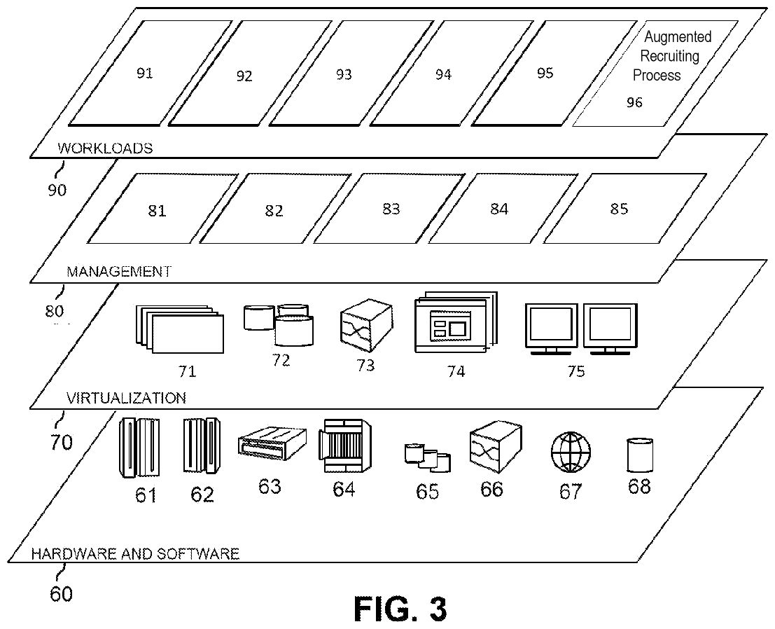

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and augmented recruiting process 96.

Implementations of the invention may include a computer system/server 12 of FIG. 1 in which one or more of the program modules 42 are configured to perform (or cause the computer system/server 12 to perform) one of more functions of the augmented recruiting process 96 of FIG. 3. For example, the one or more of the program modules 42 of the augmented recruiting process 96 may be configured to: identify, by a computing device, candidate pool resources by analyzing a job description; post, by the computing device, the job description at the candidate pool resources; identify, by the computing device, candidates from the candidate pool resources; determine, by the computing device, a candidate score of each of the candidates based on candidate data from an identified candidate information source; and select, by the computing device, a set of the candidates based on the candidate score.

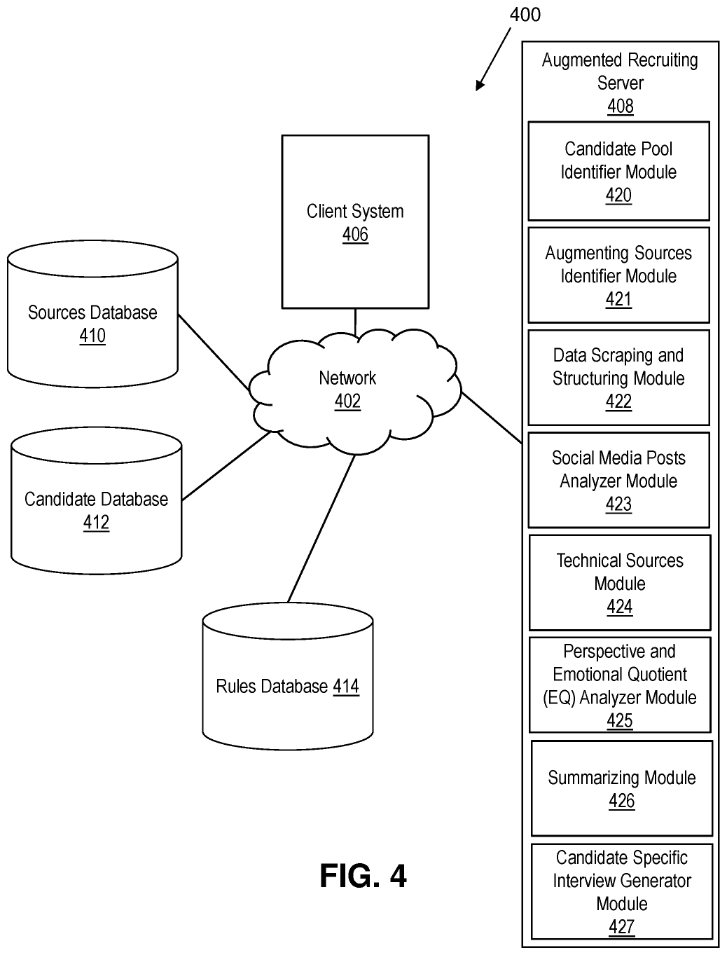

FIG. 4 shows a block diagram of an exemplary augmented recruiting environment 400 in accordance with aspects of the invention. In embodiments, the augmented recruiting environment 400 includes a network 402 enabling communication between client system(s) 406, augmented recruiting server 408, and databases 410-414 including sources database 410, candidate database 412, and rules database 414. In embodiments, the augmented recruiting server 408 may comprise the computer system/server 12 of FIG. 1, or elements thereof. In addition, the augmented recruiting server 408 may be a computing node 10 in the cloud computing environment 50 of FIG. 2. Moreover, the augmented recruiting server 408 may comprise one or more modules, each of which may comprise one or more program modules such as program modules 42 described with respect to FIG. 1.

In embodiments, the augmented recruiting server 408 comprises candidate pool identifier module 420, augmenting sources identifier module 421, data scraping and structuring module 4222, social media posts analyzer module 423, technical sources module 424, perspective and emotional quotient (EQ) analyzer module 425, summarizing module 426, and candidate specific interview generator module 427, each of which may comprise modules of program module(s) 42 of FIG. 1, for example. The augmented recruiting server 408 may include additional or fewer modules than those shown in FIG. 4. For example, in embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the candidate pool identifier module 420 is configured to extract keywords from a job description. In an exemplary embodiment, keywords may be extracted through vectorization of text of the job description, statistical analysis of the text, ranking of words in the text, node graphing of words in the text, or through other known algorithms. In an exemplary embodiment, the candidate pool identifier module 420 utilizes natural language processing methods to extract keywords from a job description. In an exemplary embodiment, skills of the potential candidates are identified in the job description based on the extracted keyword. For example, an identified skill may be associated with a popular bulletin board, forum, and/or platform that candidates with this identified skill view. Thus, a forum may be another identified resource for posting the job description.

The forum may also be another identified resource to focus a candidate search to those candidates with the identified skill. Additionally, requirements (i.e., rules) may be used in the job description including company culture specific rules or additional implicit skills. In exemplary embodiments, a company may have a culture that includes a lot of hikers or requires a lot of travel. Rules may then include candidates that have an affinity to nature and/or outdoor activities and candidates that enjoy travelling for work. Thus, regardless of a candidate's identified skills which match the specified job description, a requirement may be additionally included in the job description on outdoor forums and/or hiking forums. Requirements for a job description may include additional remarks related to the job that may not be included in the job description, such as indicators of company/team culture and/or other demographics of an ideal candidate. It should be recognized, though, that embodiments of the invention are not limited to these indicators. Requirements to a job description may be stored and managed in a rules database 414.

In exemplary embodiments, the identified skill may be described differently on various platforms. For example, a job description may look for a candidate with previous soft skills related to giving presentations. In this example, the identified skill may be associated with presentations. However, on another platform, such as sales related platforms, this soft skill may be referred to as sales pitches instead of giving presentations.

In exemplary embodiments, a candidate activity may be identified as associated with the identified skill. For example, candidate activities may include conferences, competitions, or other activities that demonstrate the identified skill or activities where potential candidates would often be participants.

In embodiments, the augmenting sources identifier module 421 may be configured to identify a candidates identification information. The candidate's identification information may provide several sources of candidate data, including identified candidate pool resources and sources of candidate data in the public domain. For example, the candidate identifiers may be matched on different platforms. Also, the candidate identifiers may be tracked and linked together to gather a candidate's complete public digital fingerprint to provide the recruiter with a full picture of the candidate's interests, skills, and relationship to the job description.

In exemplary embodiments, the augmenting sources identifier module 421 may also identify additional sources of candidate data by executing a multi-dimensional check on different platforms for the candidate's identifiers. These platforms may include technical forums, job sites, paper publication sites, and/or social media platforms. However, embodiments are not limited to these platforms. For example, other public sources may be traversed to find additional information about the candidate using the candidate identifiers. In exemplary embodiments, some sources may be filtered out based on their relevance to the job description. A source may also be categorized based on the type of information and the aspect of the candidate provided by the source.

In embodiments, the data scraping and structuring module 422 may be configured to collect candidate data, including candidate activities. The candidate identifiers provided by the augmenting sources identifier module 421 may be used to generate requests from platform specific application programming interfaces (APIs) to connect with additional data sources and to collect additional candidate activities and data. In exemplary embodiments, candidate activities, such as candidate posts on a forum may be extracted along with the metadata associated with these posts.

In embodiments, the social media posts analyzer module 423 may be configured to use the collected candidate data and analyze the textual context utilizing natural language processing methods. These natural language processing methods may include sentiment analysis, topic modelling and classification, keyword extraction, text summarization, and/or named entity recognition. In exemplary embodiments, the analysis of the textual context may determine whether the candidate's contribution to the discussion is meaningful and what tone the post uses. The meaningful contribution may be based on the content in the discussion itself and/or sentiment toward the post by other users. In exemplary embodiments, the tone may include respectfulness, sarcasm, and/or positive/negative connotations.

In embodiments, the social media posts analyzer module 423 may also be configured to extract quantifiable information such as utilizing post metadata to extract frequency of posting, recency of posts, and/or popularity of posts (e.g., likes and/or dislikes). In exemplary embodiments, the candidate may be evaluated based on the analysis of the textual context and extraction of the quantifiable information and the quantifiable information is stored with a score for the candidate activity. The score for the candidate activity may indicate a positive or negative association with the job description and/or requirements provided. In exemplary embodiments, the score may include multiple scores that can be visualized on a spider diagram.

The spider diagram may be generated by the summarizing module 426 to show contribution count, contribution quality measured by forks, traffic, likes, etc. For example, a large number of original social media posts by the candidate may indicate a large contribution count. However, poor linking or discussion after the initial posts show the candidate does not have the influence that another candidate with fewer posts and more linking and/or discussion would have.

Traffic may include views or interactions with a user's post without indicating whether other users liked or disliked the post. In particular, likes may indicate both influence and whether the candidate's posts are well received. Each of these may include a score, for example, between 0 and 10 to indicate how the post(s) scores against other posts on each candidate data source (e.g., social media platform, technical forum, etc.). In exemplary embodiments, the forks of the spider diagram in the summarizing module 426 include shares, responses, etc., that are associated with other user activities that indicate a respect or interest in the candidate's activity.

In embodiments, the social media posts analyzer module 423 may also be configured to detect unoriginal posts (i.e., copied posts) by the candidate. Accordingly, when a candidate posts new activities, the post is analyzed for originality. Items in the same index of the post are pulled out and the term frequency-inverse document frequency (TF-IDF) of words in the post are calculated against a set of documents/activities on the platform and related platforms/posts. The TF-IDF is a text vectorization method that relies upon statistics to weigh each of the words in the text. For example, in one non-limiting exemplary implementation, the top 10% of original words from the TF-IDF calculation are found and proper nouns are filtered out. Based on the remaining number of original words exceeding a threshold word count ‘n’, the post is deemed original. If less than the threshold word count n occurs, the post is then deemed unoriginal. For example, original technical ideas may indicate greater strengths in the technical subject described in the post. The quality and value of original posts may indicate greater respect for the candidate. However, reactions to unoriginal posts may be weighted more lightly.

In embodiments, the technical sources module 424 may be configured to analyze posts by a candidate on sources of candidate data that may be technical sources. The technical sources module 424 may utilize natural language processing, but may also include access to technical background data to determine the relevance to technical skills in the job description. In other words, the technical skills noted in the job description may be matched to analyzed technical skills determined by the technical sources module 424.

In embodiments, the perspective and emotional quotient (EQ) analyzer module 425 may be configured to be utilized with the social media posts analyzer module 423 and the data scraping and structuring module 422. In exemplary embodiments, the perspective and EQ analyzer module 425 utilizes natural language processing methods to analyze candidate activities to determine a tone and respect for the candidate's activities. In exemplary embodiments, the perspective and EQ analyzer module 425 also may determine respect for the candidate's activities based on extracted information about the candidate's activities, including likes, traffic, forks based on the candidate's activities, etc.

In embodiments, the summarizing module 426 may be configured to summarize the candidate data to describe scores and/or candidate traits (e.g., strengths and weaknesses of the candidate) based on the collected candidate data. The summarizing module 426 may utilize the results of the social media posts analyzer module 423 and the technical sources analyzer 424 to show the candidate's traits and how they may relate and/or match the job description. In exemplary embodiments, the summarizing module 426 may also generate the spider diagram to better visualize the analysis of candidates scores, activities, and traits. In exemplary embodiments, the summarizing module 426 may also generate benchmarks for comparing a candidate data to approximate candidate scores to account for all those of other users of a platform.

In embodiments, the candidate specific interview generator module 427 may be configured to generate and suggest candidate specific questions for the interview that may provide further insight into a candidate's traits that are associated with the job description. For example, a candidate activity that had many views may be selected for technical questions regarding the candidate activity and may expand upon the subject of the candidate activity. In exemplary embodiments, the candidate specific interview question may be drawn from analyzed candidate traits that are determined to be a candidate strength.

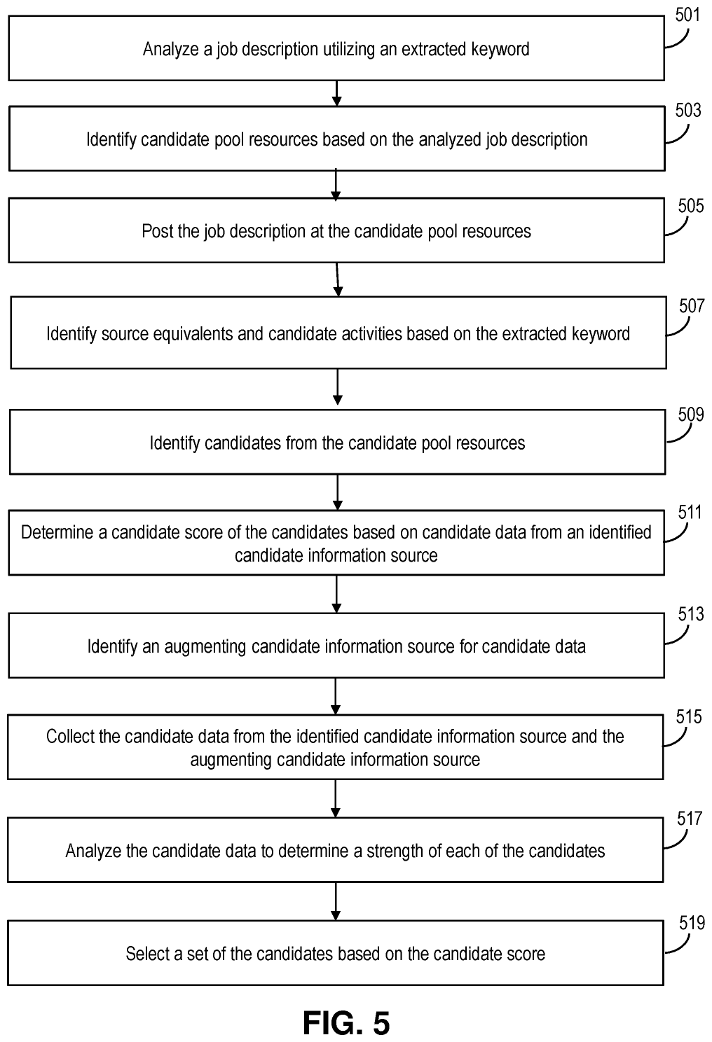

FIG. 5 shows a flowchart of an exemplary method in accordance with aspects of the present invention. Steps of the method may be carried out in the environment of FIG. 4 and are described with reference to elements depicted in FIG. 4.

At step 501, the augmented recruiting server 408 of FIG. 4 may analyze a job description utilizing a keyword. In embodiments, and as described with respect to FIG. 4, the job description may be analyzed using the candidate pool identifier module 420. Sources in which candidates may be drawn, may be stored, managed, and selected from sources database 410. In exemplary embodiments, the keywords may be extracted from the job description to identify sources for the candidate pool. For example, job descriptions with “statistical analysis” skill requirements may be extracted.

At step 503, the augmented recruiting server 408 of FIG. 4 may identify candidate pool resources based on the analyzed job description. In embodiments, and as described with respect to FIG. 4, the candidate pool resources may be identified based on the analyzed job description keywords using the candidate pool identifier module 420. For example, with regards to the “statistical analysis” skill, the candidate pool identifier module 420 may determine that the “statistical analysis” requires a mathematics background and may then direct the augmented recruiting server 408 to sources such as mathematics forums, and/or other forums related to particular fields of study (e.g., in this case, “statistical analysis” forums) within mathematics.

At step 505, the augmented recruiting server 408 of FIG. 4 may post the job description at the candidate pool resources. In embodiments, and as described with respect to FIG. 4, the job description may be posted to different platforms of the candidate pool resources that were identified based on the analyzed job description keywords using the candidate pool identifier module 420. For example, with regards to the “statistical analysis” skill, the job description may then be posted by the candidate pool identifier module 420 to the mathematics forums (i.e., the “statistical analysis” forums).

At step 507, the augmented recruiting server 408 of FIG. 4 may identify source equivalents and candidate activities based on the extracted keyword. In embodiments, and as described with respect to FIG. 4, source equivalents to the candidate pool resources may be identified utilizing the candidate pool identifier module 420. Although some mathematics and “statistical analysis” forums may already be stored in the source database 410, additional currently untracked sources related to the same subject matter may be added through additional searches of the keywords for public forums on the Internet.

At step 509, the augmented recruiting server 408 of FIG. 4 may identify candidates from the candidate pool resources. In embodiments, and as described with respect to FIG. 4, the candidate pool identifier module 420 may identify candidates matching the identified skills from the job description. In exemplary embodiments, these identified candidates may be stored and managed in the candidate database 412 along with candidates received through the job posting.

In embodiments, and as described with respect to FIG. 4, the candidate identity may be extracted by the augmenting sources identifier module 421 to link the identified and received candidates to accounts across multiple platforms. For example, the augmented recruiting server 408 may identify variations to a candidate's identifiers to match unknown accounts on other platforms and determine whether other sources may include the candidate's public digital footprint.

At step 511, the augmented recruiting server 408 of FIG. 4 may determine a candidate score of the candidates based on candidate data from an identified candidate information source. In embodiments, and as described with respect to FIG. 4, the data scraping and structuring module 422 collects the candidate activities across source platforms to provide recruiters with a holistic view of the candidate from their public digital footprint. In exemplary embodiments, the collected data may be candidate data that includes both the content of the candidate activities, and metadata related to the candidate activities.

At step 513, the augmented recruiting server 408 of FIG. 4 may identify an augmenting candidate information source for candidate data. In embodiments, and as described with respect to FIG. 4, the candidate identity may be extracted by the augmenting sources identifier module 421. For example, the augmented recruiting server 408 may search for additional sources/platforms based on the known candidate activities. In particular, some posts by a candidate may be cross-posted to unknown platforms. Further, the augmented recruiting server 408 may search for additional sources using the candidate identifiers.

At step 515, the augmented recruiting server 408 of FIG. 4 may collect the candidate data from the identified candidate information source and the augmenting candidate information source. In embodiments, and as described with respect to FIG. 4, the data scraping and structuring module 422 may collect the candidate data from both candidate information sources (e.g., known sources of candidate data) and augmenting candidate information sources (e.g., determined sources of candidate data).

At step 517, the augmented recruiting server 408 of FIG. 4 may analyze the candidate data to determine a strength of each of the candidates. In embodiments, and as described with respect to FIG. 4, the social media posts analyzer module 423, technical sources module 424, and perspective and EQ analyzer module 425 may be used to analyze the collected candidate data. In exemplary embodiments, candidate data may include candidate activity content, and the metadata associated with the candidate activity. The content may provide a context to the candidate activities, which indicate respectfulness, sarcasm, and/or positive/negative connotations, and/or the respect of other users of each platform from which the candidate activity is collected. The metadata of the candidate activity may quantifiably indicate frequency of postings, recency of posts, and/or popularity of posts (e.g., likes and/or dislikes).

Based on this analyzed information regarding the collected candidate data, a score and/or skills/traits of the candidate may be identified and weighted. For example, a technical post about statistical analysis with no responses by other users may be weighted more lightly (i.e., weighted less with a lower score) and provide less insight into a candidate's technical strengths than a technical post related to math with hundreds of likes, views, and/or shares, which may be weighted more with a higher score.

In exemplary embodiments, quantifiable inferences and/or information may be drawn from the content and metadata of the candidate activity. In exemplary embodiments, the quantifiable information associated with the candidate activities include sentiment of the social media posts, frequency of posting, novelty of the social media posts, engagement by other users, and relevance to the job description. In exemplary embodiments, the analyzed candidate activities may be utilized to determine candidate traits that are considered strengths of the candidate and may match the job description.

At step 519, the augmented recruiting server 408 of FIG. 4 may select a set of the candidates based on the candidate score. In embodiments, and as described with respect to FIG. 4, the summarizing module 426 may organize and provide a set of the highest scoring candidates for the job description. In exemplary embodiments, the augmented recruiting server 408 also may summarize the candidate score and candidate traits that match and make the candidate a fit for the job description and the company. In exemplary embodiments, the candidate score indicates contribution count, contribution quality measured by forks, traffic, likes of the candidate activities, etc.

In an example embodiment, a recruiter may want to hire for a data operations role, which is a new role for the industry. In known systems, direct string matches for candidates hit (i.e., match) on different job profiles of candidates. Further, in known systems, other platforms provide no hits (i.e., matches) for candidates. In contrast, by using the augmented recruiting server 408, the recruiter may identify candidates that have experience in data research, data annotation, and data generation for data-operations roles.

In embodiments, based on these additional terms, other job platforms may return additional candidates to the recruiter. Once these candidates are identified, the recruiter may wish to filter and rank the candidates. Thus, additional candidate data may be collected and analyzed to rank and score the candidates. In embodiments, each of these identified candidates have known candidate identifiers. However, each candidate may also utilize different candidate identifiers for different platforms. Accordingly, candidate identifier attribution may be used to match candidate identifiers on different platforms. Further, originality of candidate activities (e.g., social posts) may be computed to determine similar entries at different sites.

For a more holistic evaluation, candidate social media and technical source posts may be analyzed for interactions and interests to determine applicability to job description skills. In embodiments, once the candidate activities are analyzed, a summary of the candidates technical and non-technical activities may be provided to the recruiter to determine fit with the job description and company and/or team culture. Strengths and weaknesses related to the summarized candidate activities may provide additional detailed questions that are adapted to the individual candidate to provide additional insights into the candidate.

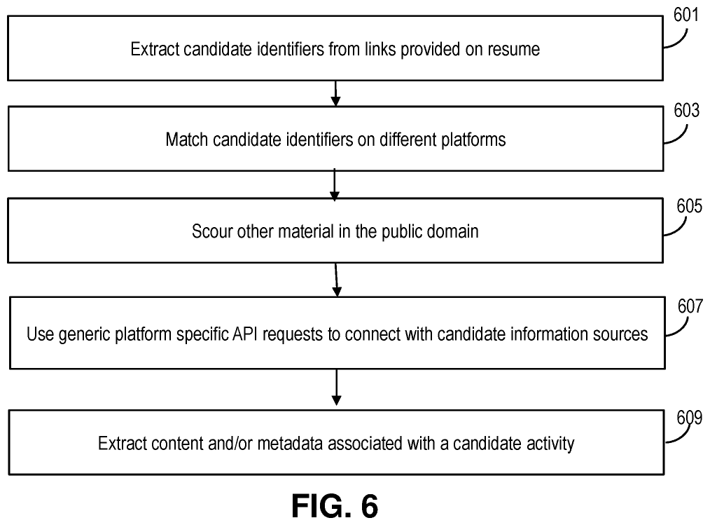

FIG. 6 shows a flowchart of an exemplary method of identifying candidate activities and candidate information sources in accordance with aspects of the invention. Steps of the method may be carried out in the environment of FIG. 4 and are described with reference to elements depicted in FIG. 4.

At step 601, the augmented recruiting server 408 of FIG. 4 may extract candidate identifiers from links provided on a resume. In exemplary embodiments, a candidate resume may include candidate identification (e.g., name) and links to their social media and/or accounts on various platforms. Based on this information, the user names and/or handles from these links may be collected.

At step 603, the augmented recruiting server 408 of FIG. 4 may match candidate identifiers on different platforms. In exemplary embodiments, the collected candidate identifiers and background information from the resume may be utilized to search other platforms for matching candidate accounts. In exemplary embodiments, matching accounts may be linked together under the candidate information to track candidate activities on these accounts.

At step 605, the augmented recruiting server 408 of FIG. 4 may scour (i.e., search) other material in the public domain. In exemplary embodiments, content in the resume and/or other candidate identifiers may be utilized to search for other material in the public domain. For example, a press report in the public domain about a candidate's activities may be searched.

At step 607, the augmented recruiting server 408 of FIG. 4 may utilize platform specific API requests to connect with candidate information sources. In exemplary embodiments, the identified platforms may utilize different data request methods. Thus, platform specific API requests may be generated to collect the public candidate activity information.

At step 609, the augmented recruiting server 408 of FIG. 4 may extract content and/or metadata associated with a candidate activity. In exemplary embodiments, the collected public candidate activity information may be analyzed to extract and determine the content and context of the candidate activity. For example, each candidate activity may be analyzed and identified as technical or non-technical data and/or the frequency and time of candidate activities may be tracked.

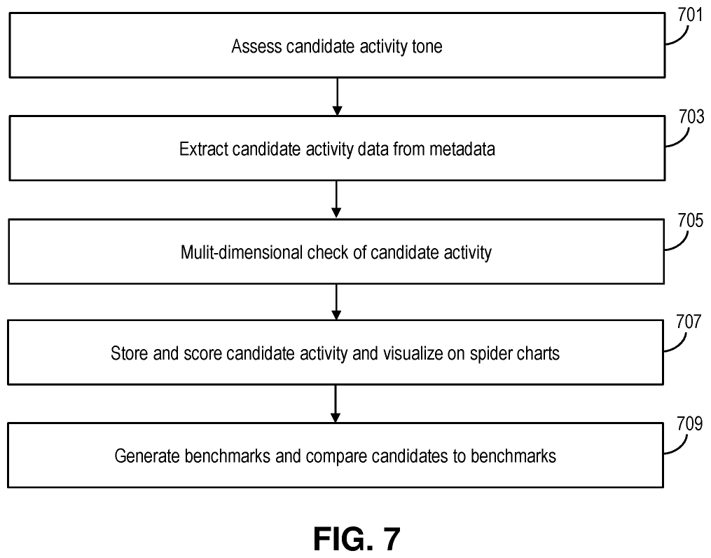

FIG. 7 shows a flowchart of an exemplary method of analyzing candidate activities in accordance with aspects of the invention. Steps of the method may be carried out in the environment of FIG. 4 and are described with reference to elements depicted in FIG. 4.

At step 701, the augmented recruiting server 408 of FIG. 4 may assess candidate activity tone. In exemplary embodiments, the tone of a candidate activity may be determined a providing a constructive contribution of the candidate's activity. For example, the assessment of the constructive contribution of the candidate's activity may include whether the candidate is being respectful, sarcastic, or positive in their candidate activity. In exemplary embodiments, the tone may be determined through natural language processing methods extracting keywords and/or sentiment. In exemplary embodiments, the tone may also be inferred by analyzing responses to the candidate's activity. For example, users may respond poorly to sarcasm or poorly articulated ideas.

At step 703, the augmented recruiting server 408 of FIG. 4 may extract candidate activity data from the metadata. In exemplary embodiments, data about the candidate activity (i.e., metadata) may be extracted to further determine sentiment and tone through popularity (i.e., likes/forks and/or other responses indicating agreement/disagreement), frequency and recency of the candidate activity, and/or views.

At step 705, the augmented recruiting server 408 of FIG. 4 may perform a multi-dimensional check of candidate activity. In exemplary embodiments, additional public candidate activities may be searched for and collected. For example, papers published by a candidate may be searched for and collected.

At step 707, the augmented recruiting server 408 of FIG. 4 may store and score candidate activity and visualize these scores on spider diagrams. In exemplary embodiments, the candidate activities may be collected and stored for scoring. The candidate activities may be scored based on many factors including contribution count (i.e., amount of activity) and contribution quality (i.e., respect for the activity by other users/peers based on forks, likes, views, etc.). In exemplary embodiments, these analyzed and scored candidate activities are visualized in a chart, e.g., a spider diagram.

At step 709, the augmented recruiting server 408 of FIG. 4 may generate benchmarks and compare candidates to the benchmarks. In exemplary embodiments, as more information is collected, benchmarks for candidates may be determined such as an average number of posts, comments, likes, etc., to compare activities, as well as compare candidates to one another. For example, a candidate with little activity and many likes in a technical field may be evaluated (i.e., have a score) better than another candidate that has a lot of activity and very little respect for their activity.

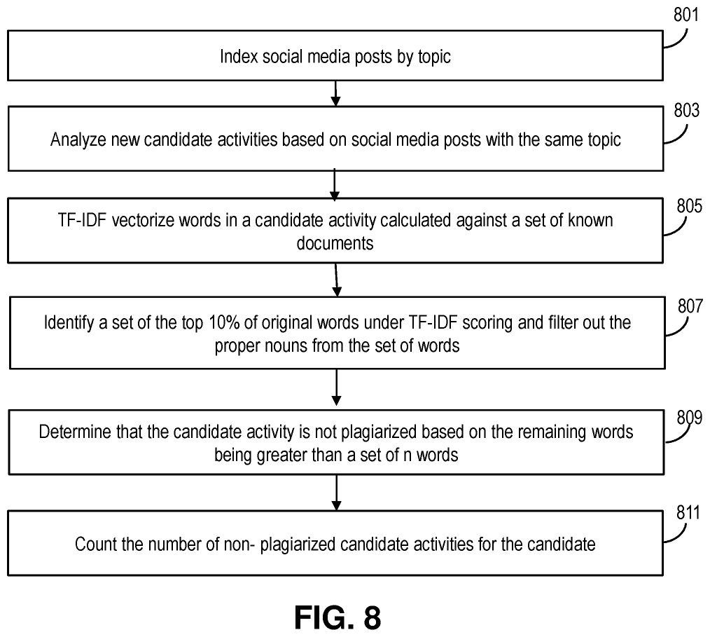

FIG. 8 shows a flowchart of an exemplary method of determining originality of a candidate activity in accordance with aspects of the invention. Steps of the method may be carried out in the environment of FIG. 4 and are described with reference to elements depicted in FIG. 4.

At step 801, the augmented recruiting server 408 of FIG. 4 may index social media posts by topic. In exemplary embodiments, indexing social media posts may reduce the number of documents to verify originality.

At step 803, the augmented recruiting server 408 of FIG. 4 may analyze new candidate activities based on social media posts with the same topic. In exemplary embodiments, the new post is indexed by topic to be compared against other activities in that same topic.

At step 805, the augmented recruiting server 408 of FIG. 4 may TF-IDF vectorize words in a candidate activity calculated against a set of known documents. In exemplary embodiments, the known documents include the group of activities that have been indexed in the same topic.

At step 807, the augmented recruiting server 408 of FIG. 4 may identify a set of the top 10% (or other predetermined percentage) of original words under TF-IDF scoring and filter out the proper nouns from the set of words. In this exemplary implementation, the 10% of original words may be removed to prevent skewed statistical analysis towards plagiarism. Without filtering out the proper nouns from the set of original words, plagiarism may be determined in far greater numbers than actual instances of plagiarism.

At step 809, the augmented recruiting server 408 of FIG. 4 may determine that the candidate activity is not plagiarized based on the remaining words being greater than a set of n words. In exemplary embodiments, the remaining words in the activity are compared to a set of n words to determine whether plagiarism occurs.

At step 811, the augmented recruiting server 408 of FIG. 4 may count the number of non-plagiarized candidate activities for the candidate. In exemplary embodiments, non-original activity by a candidate may be scored against a candidate. For example, original ideas that are well received, are more valuable, and show better understanding of the topic of the activity than unoriginal posts that are well received.

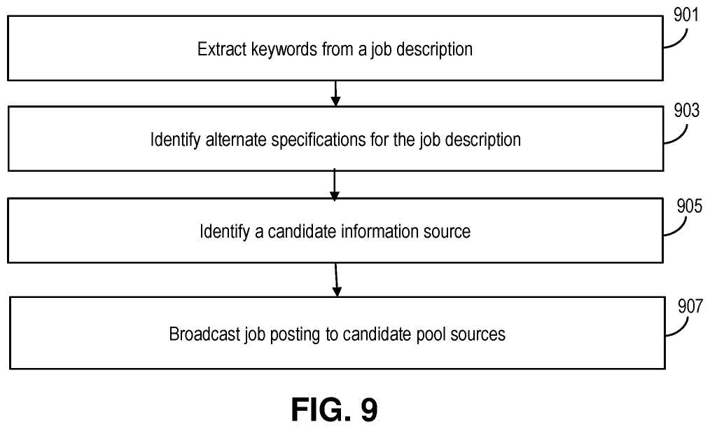

FIG. 9 shows a flowchart of an exemplary method of identifying candidate pool resources in accordance with aspects of the invention. Steps of the method may be carried out in the environment of FIG. 4 and are described with reference to elements depicted in FIG. 4. The candidate pool identifier 420 and augmenting sources identifier 421 may be utilized to execute the steps of FIG. 9 as previously described.

At step 901, the augmented recruiting server 408 of FIG. 4 may extract keywords from a job description. In an exemplary embodiment, keywords may be extracted through vectorization of text of the job description, statistical analysis of the text, ranking of words in the text, node graphing of words in the text, or through other algorithms. In an exemplary embodiment, the candidate pool identifier module 420 utilizes natural language processing methods to extract keywords from a job description. By extracting the keywords from the job description, the augmented recruiting server 408 may identify candidate pool resources as sources for posting of the job description and collection and identification of potential candidates.

At step 903, the augmented recruiting server 408 of FIG. 4 may identify alternative specifications for the job description that may be used on different platforms. Different platforms may use different terminology and/or standards for job descriptions. Thus, an alternative specification for the job description may be necessary.

At step 905, the augmented recruiting server 408 of FIG. 4 may identify a candidate information source. In exemplary embodiments, the candidate information source may be a source of information about a candidate's public digital activity. Some of these candidate information sources may overlap with candidate pool resources. In embodiments, the candidate pool resources may include platforms that may not be utilized for job postings (e.g., some social media platforms or other platforms which only include candidate activity) and may not be directed toward the technical aspects (i.e., skills) of the job description. In exemplary embodiments, when no candidate information has been taken, the candidate information sources may be identified from the analyzed job description. For example, a skill in the job description may include a keyword associated with mathematics, based on this identification, mathematics forums may be identified as candidate information sources.

In exemplary embodiments, the candidate information sources may include known sources from a candidates resume and unknown sources found through scouring (i.e., searching) public databases that are associated with the job description. In exemplary embodiments, the candidate information sources may be identified through identified skills in the job description and/or candidate information (e.g., resume). These sources of information about the candidate may include associated candidate activities, such as conferences which a candidate may have attended, hackathon, other competitions, and/or posts by the candidate on public forums or social media.

At step 907, the augmented recruiting server 408 of FIG. 4 may broadcast the job posting to a candidate pool resource. Based on the identified candidate information sources and identified candidate pool resources, the job description may be posted on these identified platforms.

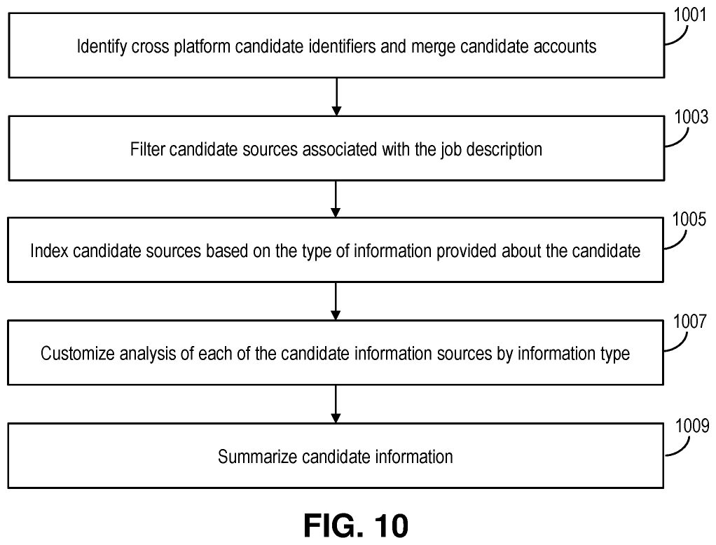

FIG. 10 shows a flowchart of an exemplary method of analyzing candidate activities and summarizing candidate information in accordance with aspects of the invention. Steps of the method may be carried out in the environment of FIG. 4 and are described with reference to elements depicted in FIG. 4. The candidate pool identifier 420, augmenting sources identifier 421, and summarizer 426 may be utilized to execute the steps of FIG. 10 as previously described.

At step 1001, the augmented recruiting server 408 of FIG. 4 may identify cross platform candidate identifiers and merge candidate accounts. Candidate's identifiers may be extracted from the candidate resume and variants on the candidate identifiers and/or based on candidate background information may be utilized to further identify user names and handles for the different platforms (e.g., the different candidate pool resources and candidate information sources). The augmented recruiting server 408 may use the background information to match candidate identifiers on these different platforms. For example, a user name with the candidate's full name, but different physical location (from the one provided on the candidate resume) may be disregarded.

At step 1003, the augmented recruiting server 408 of FIG. 4 may filter candidate sources associated with the job description. In exemplary embodiments, once these platforms and candidate accounts of these platforms are identified, only the platforms associated with the technical aspects of the job description may be utilized. Thus, non-technical sources of information about a candidate may be filtered.

At step 1005, the augmented recruiting server 408 of FIG. 4 may index candidate information sources based on the type of information provided about the candidate. In exemplary embodiments, the candidate information sources from the platforms may be indexed (i.e., classified) based on the type of information. For example, candidate posts on a technical forum may be indexed as forum posts.

At step 1007, the augmented recruiting server 408 of FIG. 4 may customize analysis of each of the candidate information sources by information type. In exemplary embodiments, the indexed candidate information sources may be utilized to determine how to analyze candidate activities based on their information type. For example, a forum post will be collected and analyzed differently than a job site. A forum post may be analyzed for originality, technical content, tone, and sentiment by other users. In addition, a job site posting may be analyzed for context to match candidate descriptions on different resume postings.

At step 1009, the augmented recruiting server 408 of FIG. 4 may summarize candidate information. In exemplary embodiments, the analyzed candidate activities may be compiled and summarized as part of the collected public digital footprint of the candidate. For example, the compiled activities may be scored as consistency of posting, technicality of posts, originality of posts, etc. In exemplary embodiments, each analyzed candidate activity may include a summarization. For example, the candidate activity may include a scoring of the tone of the post, sentiment by other users, as well as metadata about the post.

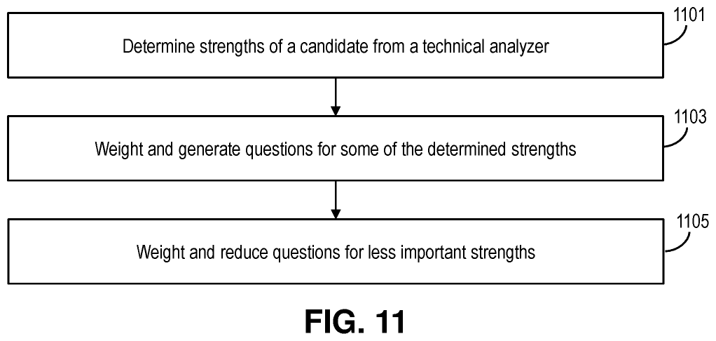

FIG. 11 shows a flowchart of an exemplary method of generating adapted interview questions in accordance with aspects of the invention. Steps of the method may be carried out in the environment of FIG. 4 and are described with reference to elements depicted in FIG. 4.

At step 1101, the augmented recruiting server 408 of FIG. 4 may determine strengths of a candidate from a technical analyzer. In exemplary embodiments, the candidate pool resources and candidate information sources may provide insight into technical strengths of the candidate by analyzing the content and context of the candidate activities as well as resume notes. For example, a candidate posting about very technical subject matter may be identified as technically strong in that specific field. Further, the sentiment of peers in the technical field may be analyzed to determine whether the candidate's posts are well respected or have many detractors.

At step 1103, the augmented recruiting server 408 of FIG. 4 may weigh and generate more questions for the determined strengths. In exemplary embodiments, technical strengths that match a job description are emphasized and more questions may be generated to delve deeper into candidate actions associated with the matching technical strength. For example, a post about a field of study closely related to the job description may result in further questions being generated about that particular post. The interviewer may delve more deeply into why or how the candidate thought of the particular post.

At step 1105, the augmented recruiting server 408 of FIG. 4 may weigh and reduce questions for less important strengths. In exemplary embodiments, some strength of a candidate may have less technical application to the job description. Thus, strengths may be de-emphasized and weighted less (i.e., a lower weighted score) than other technical strengths that better match the job description.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 1 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
identifying, by a computing device, candidate pool resources by analyzing a job description;
posting, by the computing device, the job description at the candidate pool resources;
identifying, by the computing device, candidates from the candidate pool resources;
determining, by the computing device, a candidate score of each of the candidates based on candidate data from an identified candidate information source; and
selecting, by the computing device, a set of the candidates based on the candidate score.

2. The method of claim 1, further comprising determining a strength of each of the candidates based on an analysis of the candidate data from the identified candidate information source.

3. The method of claim 2, further comprising determining a candidate specific interview question based on the analysis of the candidate data and the job description.

4. The method of claim 2, further comprising:
weighting the strength of each of the candidates based on an amount of the candidate data that supports the strength; and
determining more candidate specific interview questions for the weighted strength higher than another strength.

5. The method of claim 1, wherein the analyzing of the job description further comprises analyzing the job description by utilizing an extracted keyword, and identifying source equivalents and candidate activities based on the extracted keyword.

6. The method of claim 1, further comprising:
identifying an augmenting candidate information source for the candidate data;
collecting the candidate data from the identified augmenting candidate information source; and
analyzing the candidate data to determine a strength of each of the candidates.

7. The method of claim 6, further comprising:
linking the identified augmenting candidate information source; and
extracting additional candidate data from the identified augmenting candidate information source.

8. The method of claim 6, further comprising analyzing social media posts of the candidate data for metadata and content of the social media posts.

9. The method of claim 8, further comprising determining quantifiable information associated with the social media posts including data associated with at least one of:
sentiment of the social media posts;
frequency of posting;
novelty of the social media posts;
engagement by other users; and
relevance to the job description.

10. The method of claim 9, wherein a novelty of the social media posts is determined by comparing the social media posts against a set of documents to determine whether the social media posts meet a threshold novelty count indicating that the social media posts are not plagiarized.

11. The method of claim 1, further comprising summarizing the candidate data to indicate fit of each of the candidates to the job description.

12. The method of claim 1, further comprising visualizing the candidate data using at least one spider diagram to show candidate activities, the candidate activities including data associated with at least one of:
contribution count;
contribution quality;
traffic; and
likes.

13. The method of claim 1, wherein the computing device includes software provided as a service in a cloud environment.

14. A computer program product comprising one or more computer readable storage media having program instructions collectively stored on the one or more computer readable storage media, the program instructions executable to:
analyze a job description utilizing an extracted keyword;
identify candidate pool resources based on the analyzed job description;
post the job description at the candidate pool resources;
identify source equivalents and candidate activities based on the extracted keyword;
identify candidates from the candidate pool resources;
determine a candidate score of each of the candidates based on an identified candidate information source; and
select a candidate set of the candidates based on the candidate score.

15. The computer program product of claim 14, wherein the program instructions are executable to determine a strength of each of the candidates based on an analysis of the candidate data from the identified candidate information source.

16. The computer program product of claim 15, wherein the program instructions are executable to determine a candidate specific interview question based on the analysis of the candidate data and the job description.

17. The computer program product of claim 15, wherein the program instructions are executable to:
weigh the strength based on an amount of the candidate data that supports the strength; and
determine more candidate specific interview questions based on the strength weighted higher than another strength.

18. A system comprising:
a processor, a computer readable memory, one or more computer readable storage media, and program instructions collectively stored on the one or more computer readable storage media, the program instructions executable to:
analyze a job description;
identify candidate pool resources based on the job description;
identify candidates from the candidate pool resources;
determine a candidate score of the candidates based on candidate data from an identified candidate information source;
identify an augmenting candidate information source for candidate data;
collect the candidate data from the identified augmenting candidate information source;
analyze the candidate data to determine a strength of each of the candidates; and
select a candidate set of the candidates based on the candidate score and the determined strength of each of the candidates.

19. The system of claim 18, wherein the program instructions are executable to:
link the identified augmenting candidate information source; and
extract additional candidate data from the identified augmenting candidate information source.

20. The system of claim 18, wherein the program instructions are executable to:
analyze social media posts of the candidate data for metadata and content of the social media posts.
